(19) United States
(12) Patent Application Publication
(10) Pub. No.: US 2024/0204475 A1
(43) Pub. Date: Jun. 20, 2024

(54) APPARATUS AND METHOD FOR GENERATING OPTICAL FREQUENCY COMBS AND SOLITONS

(71) Applicants: KOREA ADVANCED INSTITUTE OF SCIENCE AND TECHNOLOGY, Daejeon (KR); KOREA RESEARCH INSTITUTE OF STANDARDS AND SCIENCE, Daejeon (KR)

(72) Inventors: Hansuek LEE, Daejeon (KR); In Hwan DO, Daejeon (KR); Daewon SUK, Daejeon (KR); Jae Hoon LEE, Daejeon (KR); Hyun-Gue HONG, Daejeon (KR); Dai-Hyuk YU, Daejeon (KR)

(21) Appl. No.: 18/530,590

(22) Filed: Dec. 6, 2023

(30) Foreign Application Priority Data
Dec. 12, 2022 (KR) 10-2022-0172778
Dec. 5, 2023 (KR) 10-2023-0174903

(51) Int. Cl. H01S 3/30; H01S 3/094; H01S 3/131; H01S 3/067; H01S 3/16

(52) U.S. Cl. CPC H01S 3/302; H01S 3/094053; H01S 3/1312; H01S 3/06716; H01S 3/1608; H01S 2301/085

(57) ABSTRACT

An apparatus for generating optical frequency combs and solitons includes a pump laser configured to output a pump signal with a pump wavelength, and a resonator module connected to the pump laser through an optical path and including a resonator and a waveguide structured to adjust a degree of coupling. The resonator generates at least one of pump combs at the pump wavelength, Raman combs at a Raman scattering wavelength or solitons, through different nonlinear phenomena.

### CROSS-REFERENCE TO RELATED APPLICATION

This application claims priority to and the benefit of Korean Patent Application No. 10-2022-0172778 filed in the Korean Intellectual Property Office on Dec. 12, 2022, and Korean Patent Application No. 10-2023-0174903 filed in the Korean Intellectual Property Office on Dec. 5, 2023, the entire contents of which are incorporated herein by reference.

### BACKGROUND

### (a) Field of the Invention

The present disclosure relates to the generation of optical frequency combs and solitons.

### (b) Description of the Related Art

An optical frequency comb is an optical signal having an equal interval in a frequency domain, and a soliton has a pulse shape in a sub-nanosecond time domain. Recently, studies have been conducted on technologies for generating optical frequency combs within very small chip elements based on the Kerr nonlinearity of a high-quality factor resonator.

The resonator, which receives a pump signal outputted from a pump laser, generates solitons using strong nonlinearity. When the soliton occurs, the internal temperature of the resonator changes instantaneously and becomes thermally unstable. Therefore, to maintain the soliton, a pump frequency needs to be feedback-controlled at a high rate using an external device. To perform the feedback control, additional complicated setup components such as a servo, a phase modulator, and an electric mixer are required. However, because all the components cannot operate on a chip, the feedback control hinders the generation of chip-scale pulses.

Recent studies have shown that in the case of solitons (SBS-soliton) using stimulated Brillouin scattering (SBS), the solitons pulses may be generated and maintained without feedback control. However, because the Brillouin phonon frequency is determined by the material, these studies are inevitably limited to cases with a particular repetition rate.

### SUMMARY

The present disclosure attempts to provide an apparatus and method for generating optical frequency combs in different wavelength regions and spontaneously and deterministically generating a self-locked single soliton by adjusting relative threshold power between different nonlinear phenomena by adjusting coupling between a resonator and a waveguide.

An apparatus according to one embodiment includes: a pump laser configured to output a pump signal with a pump wavelength; and a resonator module connected to the pump laser through an optical path and including a resonator and a waveguide structured to adjust a degree of coupling. The resonator generates at least one of pump combs at the pump wavelength, Raman combs at a Raman scattering wavelength or solitons, through different nonlinear phenomena.

The degree of coupling may be adjusted based on a coupling length of the waveguide attached to the resonator.

The waveguide includes a tapered optical fiber or monolithically integrated waveguide attached to the resonator.

Relative magnitudes of threshold power of Raman scattering and threshold power of optical parametric oscillation (OPO) induced by the pump signal may be controlled based on the degree of coupling.

The resonator module may generate the pump comb at the pump wavelength by pump frequency detuning when the coupling between the resonator and the waveguide is adjusted so that the threshold power of the Raman scattering is higher than the threshold power of the OPO.

The resonator module may generate the pump comb at the pump wavelength and the Raman comb at the Raman scattering wavelength by pump frequency detuning when the coupling between the resonator and the waveguide is adjusted so that the threshold power of the Raman scattering is similar to the threshold power of the OPO.

The resonator module may further generate the soliton spontaneously under a particular pump detuning condition.

The resonator module may generate the Raman comb at the Raman scattering wavelength by pump frequency detuning and generate the pump comb by anti-stokes of the Raman comb when the coupling between the resonator and the waveguide is adjusted so that the threshold power of the Raman scattering is lower than the threshold power of the OPO.

A method of operating an apparatus for generating optical frequency combs and solitons according to another embodiment includes: controlling a relative threshold power of a first nonlinear phenomenon at a first wavelength related to a Q-factor and a second nonlinear phenomenon at a second wavelength by adjusting a degree of coupling between a resonator and a waveguide; and generating frequency combs generated by different nonlinear phenomena in the resonator while detuning a pump frequency inputted to the resonator when the resonator is adjusted to have a particular degree of coupling, in which the second wavelength is a wavelength longer than the first wavelength.

The first nonlinear phenomenon may be optical parametric oscillation (OPO) induced by a pump signal, and the second nonlinear phenomenon may be Raman scattering.

The generating the frequency comb may include generating the comb at the first wavelength by the first nonlinear phenomenon in accordance with detuning of the pump frequency when the coupling between the resonator and the waveguide is adjusted so that the threshold power of the second nonlinear phenomenon is higher than the threshold power of the first nonlinear phenomenon.

The generating the frequency comb may include generating the comb at the first wavelength and the comb at the second wavelength by the interaction between the first nonlinear phenomenon and the second nonlinear phenomenon in accordance with detuning of the pump frequency when the coupling between the resonator and the waveguide is adjusted so that the threshold power of the second nonlinear phenomenon is similar to the threshold power of the first nonlinear phenomenon.

The method may further include spontaneously generating the soliton under a particular pump detuning condition.

The generating the frequency comb may include generating the comb at the second wavelength by the second nonlinear phenomenon and generating the comb at the first wavelength by anti-stokes of the comb generated at the second wavelength in accordance with detuning of the pump frequency when the coupling between the resonator and the waveguide is adjusted so that the threshold power of the second nonlinear phenomenon is lower than the threshold power of the first nonlinear phenomenon.

The degree of coupling between the resonator and the waveguide may be adjusted based on a coupling length of the optical waveguide attached to the resonator.

According to the embodiment, the relative threshold power between the different nonlinear phenomena may be adjusted by adjusting the coupling between the resonator and the waveguide. As a result, it is possible to control the interaction dynamics between the optical parametric oscillation and the Raman scattering, which are the different nonlinear phenomena, and to use the joint effect of the different nonlinear phenomena.

According to the embodiment, the single resonator may simultaneously generate the optical frequency combs of the stable spectrum at the wavelengths distant from one another without an additional process and use the combs generated in the desired wavelength region, as necessary.

According to the embodiment, the self-locked single soliton may be spontaneously and deterministically generated and maintained under a particular condition without an external locking mechanism.

According to the embodiment, the setup is simple because stabilization through the feedback apparatus is not required.

According to the embodiment, the pumping may be performed in an anomalous dispersion region, and then the Kerr nonlinearity and the Raman nonlinearity may be simultaneously used by adjusting the coupling, unlike studies in the related art in which pumping is performed in a normal dispersion region to generate general Raman combs.

According to the embodiment, it is possible to generate the soliton having various repetition rates, unlike the Brillouin scattering soliton limited to a particular repetition rate.

### BRIEF DESCRIPTION OF THE DRAWINGS

FIG. 1 is a view illustrating an example of a soliton generator including a feedback circuit.

FIG. 2 is a view for explaining thermal behavior during the generation of solitons.

FIG. 3 is a view illustrating a setup for generating optical frequency combs and solitons according to one embodiment.

FIG. 4 is a view illustrating an image showing a state in which a resonator and a tapered optical fiber according to one embodiment are coupled.

FIG. 5 is a view for explaining an optical spectrum of a frequency comb with relative threshold power control according to one embodiment.

FIGS. 6 to 8 are views for explaining an optical spectrum variation and an RF spectrum according to red-detuning of a pump frequency according to one embodiment.

FIG. 9 is a view illustrating a result of observing a retention time of a Raman single soliton according to one embodiment.

FIG. 10 is a view illustrating the generation of an atypical envelope frequency comb from a Raman comb according to one embodiment.

FIG. 11 is a flowchart illustrating a method of generating optical frequency combs and solitons according to one embodiment.

### DETAILED DESCRIPTION OF THE EMBODIMENTS

Hereinafter, embodiments of the present disclosure will be described in detail with reference to the accompanying drawings so that those with ordinary skill in the art to which the present disclosure pertains may easily carry out the embodiments. However, the present disclosure may be implemented in various ways and is not limited to the embodiments described herein. Further, a part irrelevant to the description will be omitted in the drawings to clearly describe the present disclosure, and similar constituent elements will be designated by similar reference numerals throughout the specification.

In the description, unless explicitly described to the contrary, the word “comprise/include” and variations such as “comprises/includes” or “comprising/including” will be understood to imply the inclusion of stated elements, not the exclusion of any other elements.

In the description, reference numerals and names are designated for convenience of description, and devices are not necessarily limited to the reference numeral or name.

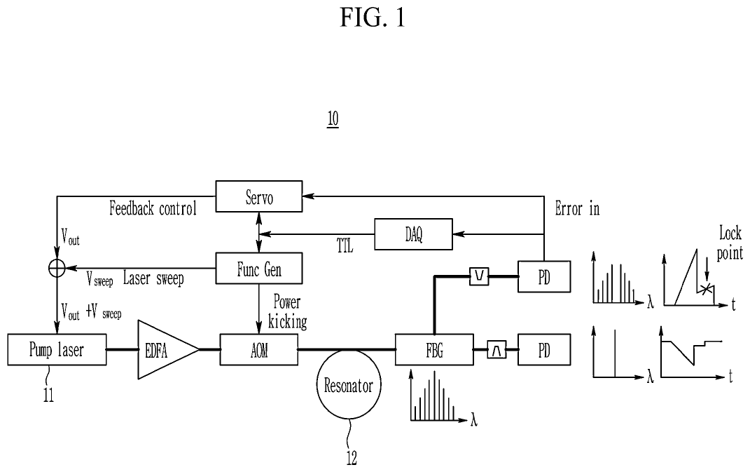

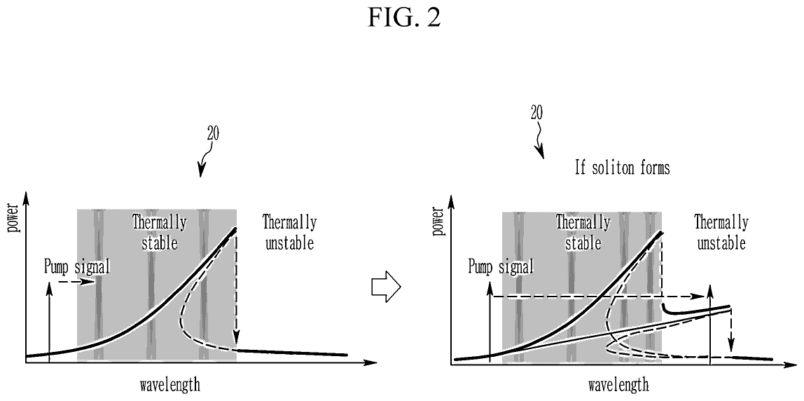

FIG. 1 is a view illustrating an example of a soliton generator including a feedback circuit, and FIG. 2 is a view for explaining thermal behavior during the generation of solitons.

Referring to FIG. 1, a soliton generator 10 in the related art inputs a pump signal, which is outputted from a pump laser 11, to a high-quality factor resonator 12 and generates a soliton pulse by using strong nonlinearity of the resonator 12.

Because the internal temperature of the resonator changes instantaneously when the soliton occurs, the pump frequency needs to be feedback-controlled at a high rate to maintain the soliton. Therefore, the soliton generator 10 in the related art requires complicated setups such as an acousto-optic modulator (AOM) for modulating the pump signal, a photodetector (PD) for controlling the pump laser 11 based on the generated pulse, a data acquisition (DAQ) such as a servo, and a function generator.

The thermal behavior during the generation of the soliton will be described in FIG. 2.

First, thermal behavior 20 in a general resonance mode will be described. As the frequency of the pump signal starts in a relatively short wavelength region and is detuned to a long wavelength region, the photocoupling starts and intracavity power gradually increases when the pump frequency becomes close to the resonance mode of the resonator 12. The intracavity power may be referred to as coupling power, resonance power, mode power, or the like.

Meanwhile, thermal behavior 21 during the generation of the soliton will be described. Because the soliton is generated in a thermally unstable long wavelength region, the pump signal needs to be detuned to the thermally unstable long wavelength region to generate the soliton. In this case, because the internal temperature of the resonator changes instantaneously because of an instantaneous change in power in the mode, the generated soliton becomes thermally unstable. The complicated external devices illustrated in FIG. 1 are used to offset the thermal instability of the soliton.

Next, an apparatus and method for generating optical frequency combs and soliton pulses of the stable spectrum without feedback control will be described.

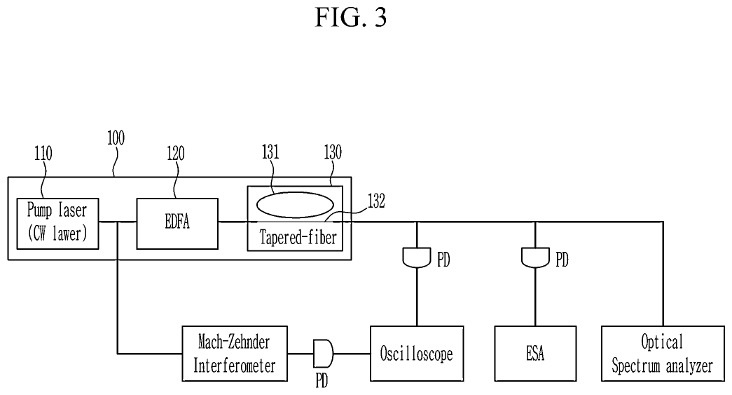

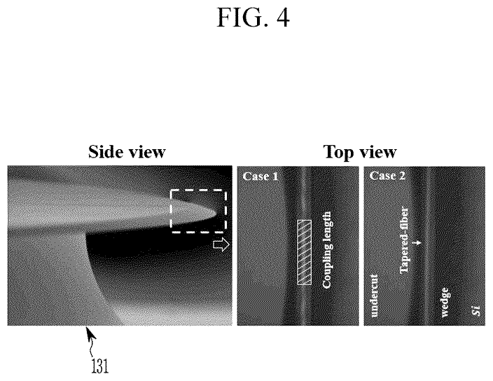

FIG. 3 is a view illustrating a setup for generating optical frequency combs and solitons according to one embodiment, and FIG. 4 is a view illustrating an image showing a state in which a resonator and a tapered optical fiber according to one embodiment are coupled.

With reference to FIG. 3, an apparatus 100 for generating optical frequency combs and solitons may include a pump laser 110, an amplifier 120, and a resonator module 130 capable of adjusting coupling between the resonator and the waveguide. Various types of measurers (an optical spectrum analyzer, an ESA, or an oscilloscope) may be connected to measure spectra and beat notes, and the acquired results may be corrected by a Mach-Zehnder interferometer (MZI).

The pump laser 110 is a laser configured to output continuous waves (CWs). The pump laser 110 may be a free-running laser that is not subjected to external feedback control. In the description, the output of the pump laser 110 may be referred to as a pump signal or a pump, and an output wavelength/output frequency may be referred to as a pump wavelength/pump frequency.

The amplifier 120 may be an erbium-doped fiber amplifier (EDFA). The amplifier 120 may amplify the output of the pump laser 110 and transmit the output to the resonator module 130.

The resonator module 130 is connected to the pump laser 110 through an optical path. The resonator module 130 may have a structure capable of adjusting a degree of coupling between the resonator and the waveguide. In this case, the waveguide means an optical waveguide. The amount of light discharged to the waveguide may vary depending on the degree of coupling, and as a result, a Q-factor may be controlled. Threshold power between different nonlinear phenomena may be controlled based on the Q-factor.

For example, the resonator module 130 may include a resonator 131 and a tapered optical fiber 132 attached to the resonator 131. The resonator 131 generates optical frequency combs and soliton pulses from the pump output through the nonlinear optical phenomenon. The resonator 131 may be a chip-scale silica micro-resonator. The resonator 131 has therein a cavity in which a plurality of resonance modes may be generated. The resonator 131 may be provided as a wedge in which the optical waveguide is a four-sided structure. The tapered optical fiber 132 attached to the resonator 131 may induce coupling with a sufficiently long length to control wavelength-dependent interference. Meanwhile, the resonator module 130 may use a monolithically integrated waveguide instead of the tapered optical fiber 132. In the description, the tapered optical fiber 132 will be described as an example, but the present disclosure need not be limited thereto.

FIG. 4 is an SEM image of the resonator 131 when viewed laterally. Case 1 shows a situation in which the resonator and the tapered optical fiber are affixed with a certain coupling length, and Case 2 is an image showing the coupling state of the resonator and the tapered optical fiber. For reference, the shown contact region is approximately estimated based on a rapid change in fringe pattern that occurs when the tapered optical fiber is attached to the resonator.

The resonator 131 may generate the optical frequency combs and solitons by controlling the interaction between different nonlinear phenomena. The interaction control may be achieved by controlling the threshold power for the nonlinear phenomena by adjusting the coupling between the resonator and the waveguide. In this case, the different nonlinear phenomena may include optical parametric oscillation (OPO) and stimulated Raman scattering. In the related art, the optical frequency combs are generated by four-wave mixing by Kerr nonlinearity. In contrast, the present disclosure may generate the optical frequency combs of the stable spectrum by using Raman scattering together.

In general, because a Raman scattering phenomenon has a higher threshold power than the Kerr nonlinear phenomena, Kerr combs are observed prior to the observation of the combs (Raman combs) with the Raman scattering wavelength. Therefore, in order to observe the Raman combs, a method is used to suppress the generation of the frequency combs by the Kerr nonlinearity in the vicinity of the pump wavelength by adjusting dispersion by changing a material or structure of an optical element. According to the studies in the related art, the different nonlinear phenomena cannot exhibit joint effects and are inevitably maintained independently.

In contrast, according to the present disclosure, it is possible to control the relative threshold power between the nonlinear phenomena by changing the Q-factor by adjusting the coupling in the resonator module 130. As a result, it is possible to generate the comb (Raman comb) with the Raman scattering wavelength and simultaneously generate the comb (pump comb) with the pump wavelength of the stable spectrum even at the periphery of the pump wavelength by anti-stokes of the Raman comb.

As described above, with the coupling-adjustable resonator module 130, it is possible to freely generate the optical frequency combs that are stably maintained and reproduced without change over time in the distant wavelength region in one resonator. In addition, it is possible to generate self-stabilized soliton pulses.

Next, the threshold power control will be described in detail.

To generate the combs with the pump wavelength and the Raman scattering wavelength through the interaction through the Raman scattering process, the abnormal dispersion needs to be satisfied in both two wavelengths. In the dispersion regime in which two types of nonlinear phenomena may occur, the generation order may be controlled by adjusting the threshold power. Because the distance between the pump wavelength and the Raman scattering wavelength is sufficiently long (e.g., about 100 nm), it is possible to control the threshold power by adjusting a total Q-factor of the wavelength. This relationship may be ascertained in Equations 1 and 2 from threshold power P^{th}_{OPO,P} related to the OPO at the pump wavelength and threshold power P^{th}_{Raman} related to Raman lasing induced by pump wavelength photons.

$${P}_{O P O , P}^{th} = \frac{π}{4} \times ( \frac{{Q}_{e , P}}{{Q}_{t , P}} ) \times \frac{{cnA}_{eff , P}}{{n}_{2} {λ}_{P} F S {{R}_{P} ( {Q}_{t , P} )}^{2}} \qquad ( Equation 1 )$$

$${P}_{R a m a n}^{th} = \frac{{π}^{2} {n}^{2}}{{λ}_{P} {λ}_{R}} \times \frac{{V}_{eff , P}}{Γ B {g}_{R}} {Q}_{e , P} \times {( \frac{1}{{Q}_{t , P}} )}^{2} \times \frac{1}{{Q}_{t , R}} {A}_{e f f} \qquad ( Equation 2 )$$

In Equations 1 and 2, Qₜ represents a total Q-factor and includes intrinsic Q-factor Qi and extrinsic Q-factor Qₑ. V_{eff} represents an effective mode volume, and A_{eff} represents an effective mode area. FSR represents a free spectrum range of the comb, and À represents a wavelength. The subscripts P and R denote the respective properties at the pump wavelength and Raman scattering wavelength. Γ represents a spatial mode overlap factor between the pump and the Raman mode, g_{R} represents a nonlinear bulk Raman gain coefficient, and B represents a correction factor of circulating power made by internal backscattering (0.5≤ B≤ 1). n represents the refractive index of a material, n₂ represents a nonlinear Kerr coefficient, and c represents a velocity of light.

A ratio between two nonlinear threshold powers may be calculated based on Equation 3 by using Equations 1 and 2. With reference to Equation 3, with the ratio between the two nonlinear threshold powers made by dividing λ_{P} by the Raman lasing and the threshold electric power of the OPO, it is possible to determine the amount of the total Q-factor required to actually manipulate the nonlinear threshold power. For example, at λ_{P}, the Raman lasing and the threshold power of the OPO may be separated and compared based on Equation 3.

$$\frac{{P}_{R a m a n}^{th}}{{P}_{OPO , P}^{th}} = \frac{4 π n {n}_{2} F S {R}_{P} {V}_{e f f , R}}{c {g}_{R} {λ}_{R} {A}_{eff , P}} \times \frac{{Q}_{t , P}}{{Q}_{t , R}} \qquad ( Equation 3 )$$

It is assumed that the mode overlap between the pump mode and the Raman mode is large and almost no backscattering occurs (i.e., Γ, B=1). The variables corresponding to the material and structure of the resonator may be obtained through known algorithms. For example, because n=1.442, n₂=2.8×10⁻²⁰ m²/W, λ_{R}=1670 nm, g_{R}=6.2×10⁻¹⁴ m/W, V_{eff}=9.78×10⁻¹³ m³, and A_{eff}=5.34×10⁻¹¹ m² in the case of the particular silica wedge micro-resonator, P^{th}_{Raman}/P^{th}_{OPO,P}≈3.3×Q_{t,P}/Q_{t,R} may be estimated. The coupling Q_{t,P}≈Q_{t,R} generally used in various nonlinear studies means that the pump induction OPO occurs and is followed by the generation of the frequency combs. However, when Q_{t,R} increases by about three times compared to Q_{t,P} by adjusting the degree of coupling, P^{th}_{Raman} and P^{th}_{OPO,P} become similar. Therefore, the Raman scattering and the pump induction OPO may occur simultaneously.

When P^{th}_{Raman} becomes lower than P^{th}_{OPO,P} as Q_{t,R} further increases, the comb (Raman comb) with the Raman scattering wavelength may be generated without the comb (pump comb) with the pump wavelength. In this case, the threshold values of the OPO and cascade Raman process (particularly, second stokes of the original pump) at λ_{R} may be recognized as being similar to those at λ_{P}. In particular, in case the total Q-factor at a second cascade Raman scattering wavelength is not greatly different from that at λ_{R}, the critical value of the OPO at λ_{R} may become smaller than the critical value in the cascade Raman process. It has been experimentally proven that Raman combs are generated before the second Stokes process is observed.

The wavelength-dependent total Q-factor may be effectively controlled by implementing a coupling scheme capable of adjusting the wavelength-dependent interference for the coupling region. The coupling method capable of adjusting the wavelength-dependent interference may be implemented by the tapered optical fiber 132 made by attaching the optical fiber to the resonator 131. The Q-factor may be independently controlled at different wavelengths by precisely controlling the interference by manipulating the coupling length. Unlike the coupler method in the related art, no significant backscattering occurs despite the physical contact between the tapered optical fiber and the resonator.

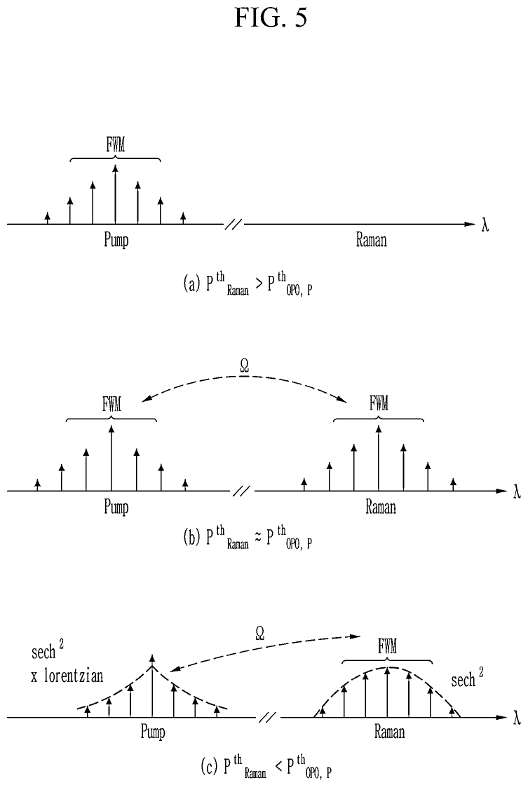

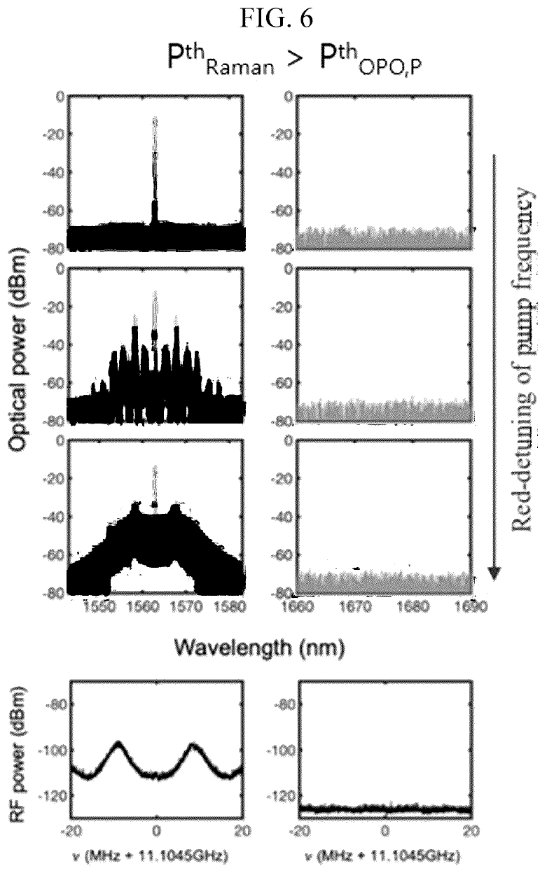

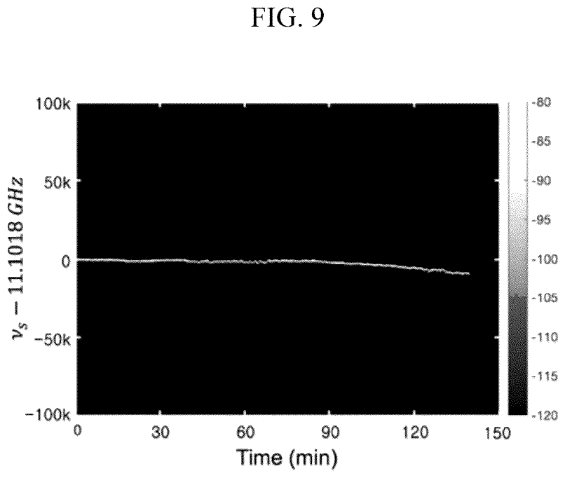

FIG. 5 is a view for explaining an optical spectrum of a frequency comb with relative threshold power control according to one embodiment, FIGS. 6 to 8 are views for explaining an optical spectrum variation and an RF spectrum according to red-detuning of a pump frequency according to one embodiment, and FIG. 9 is a view illustrating a result of observing a retention time of a Raman single soliton according to one embodiment.

Referring to FIG. 5, it is possible to control relative magnitudes between the threshold power P^{th}_{Raman} of the Raman scattering and the threshold power P^{th}_{OPO,p} of the pump induction nonlinearity (OPO) related to the Q-factor by adjusting the coupling between the resonator and the waveguide. The optical spectra of the frequency combs by the relative threshold power control may be classified into three types of regions.

With reference to FIG. 5A, in case that the threshold power P^{th}_{Raman} of the Raman scattering is higher than the threshold power P^{th}_{OPO,P} of the pump induction nonlinearity (OPO), only the pump induction OPO occurs in the resonator, and as a result, the pump comb is generated.

With reference to FIG. 5B, in case that the threshold power P^{th}_{Raman} of the Raman scattering is similar to the threshold power P^{th}_{OPO,P} of the pump induction nonlinearity (OPO), the pump induction OPO and the Raman scattering occur simultaneously in the resonator, and as a result, the pump comb and the Raman comb are generated simultaneously.

With reference to FIG. 5C, in case that the threshold power P^{th}_{Raman} of the Raman scattering is lower than the threshold power P^{th}_{OPO,P} of the pump induction nonlinearity (OPO), the Raman scattering phenomenon occurs in the resonator, and as a result, the Raman combs are generated, and the pump combs may be generated by the anti-stokes of the Raman combs.

Unlike studies in the related art in which pumping is performed in a normal dispersion region to generate general Raman combs with higher threshold power values, the pumping may be performed in an anomalous dispersion region, and then the Kerr nonlinearity and the Raman nonlinearity may be simultaneously used by adjusting the coupling between the resonator and the waveguide.

Referring to FIGS. 6 to 8, the interaction between the nonlinear phenomena may be achieved by adjusting the nonlinear threshold power through the Q-factor. This was investigated experimentally by observing the optical spectra while tuning the pump frequency adiabatically (i.e., ensuring that thermal equilibrium is always achieved during the soliton generation process). The left graph shows the optical spectrum generated in the vicinity of the pump wavelength (1563 nm), and the right graph shows the optical spectrum generated in the vicinity of the Raman scattering wavelength (to 1670 nm). In this case, the optical spectrum changes (from top to bottom) with red-detuning of the pump frequency, and the coupled intracavity power (coupled power) increases.

Referring to FIG. 6, in case that the threshold power P^{th}_{Raman} of the Raman scattering is higher than the threshold power P^{th}_{OPO,p} of the pump induction nonlinearity (OPO) (P^{th}_{Raman}≈P^{th}_{OPO,p}), the pump induction OPO occurs in the resonator as the coupling power increases. Thereafter, the Raman scattering does not occur, and the frequency comb spectrum having modulation instability (MI) is generated at the pump wavelength.

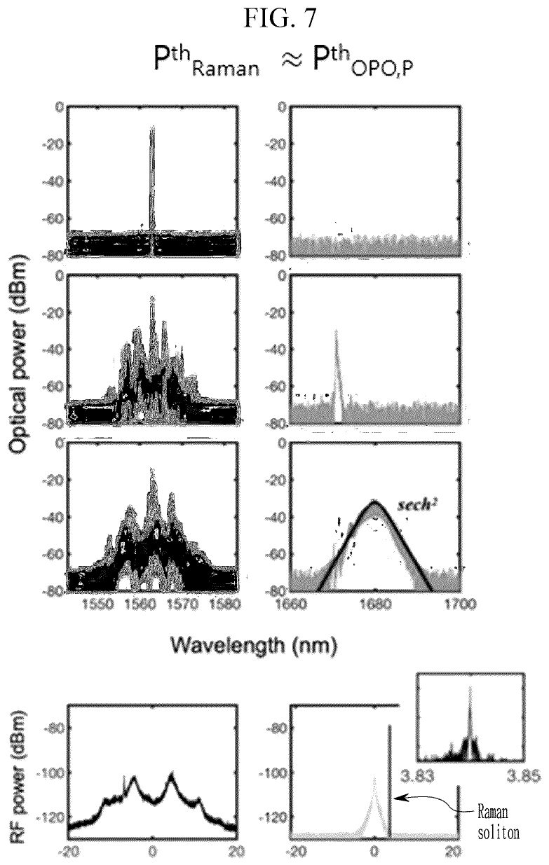

Referring to FIG. 7, in case that the threshold power P^{th}_{Raman} of the Raman scattering is similar to the threshold power P^{th}_{OPO,p} of the pump induction nonlinearity (OPO) (P^{th}_{Raman}≈P^{th}_{OPO,p}), the pump wavelength induction OPO occurs in the resonator as the coupling power increases, and the MI-comb is generated. At the same time, the stimulated Raman scattering photons appear near 1670 nm, near the maximum Raman gain. When the coupling power further increases, the Raman frequency comb having a sech² envelope profile, which is a representative property of the soliton, is generated. With reference to the RF spectrum at Raman wavelengths (graph below), the beat note of the Raman comb has a line width of 320 kHz, which is wider than the line width of the mode-locking soliton. This indicates that the comb lines, which constitute the Raman comb, may not be phase-locked to the same extent as a typical Kerr soliton. In this case, no external locking mechanism is required to generate the sech² envelope Raman comb. This is because the optical power present in the pump mode has the potential to offset the thermal instability that occurs within the Raman comb mode. Meanwhile, the RF beat note of the pump wavelength shows a distinct RF peak near 11.098 GHz within the wide RF beat note of the MI-comb. This peak indicates the presence of the anti-stokes Raman comb even though the peak is nearly obscured by the pump comb.

When the coupling power further increases in the resonator after the appearance of the Raman comb having the sech² envelope, the soliton is spontaneously and deterministically generated under a particular pump detuning condition. The generation of the soliton may be identified through the RF beat note (25 Hz) having a small line width in the RF spectrum. The RF beat note having a large line width coexists with the RF beat note of the single soliton, and this means that the single soliton state coexists with the sech² envelope Raman comb. In the measurement of the dispersion, it can be ascertained that the two combs come from different mode series.

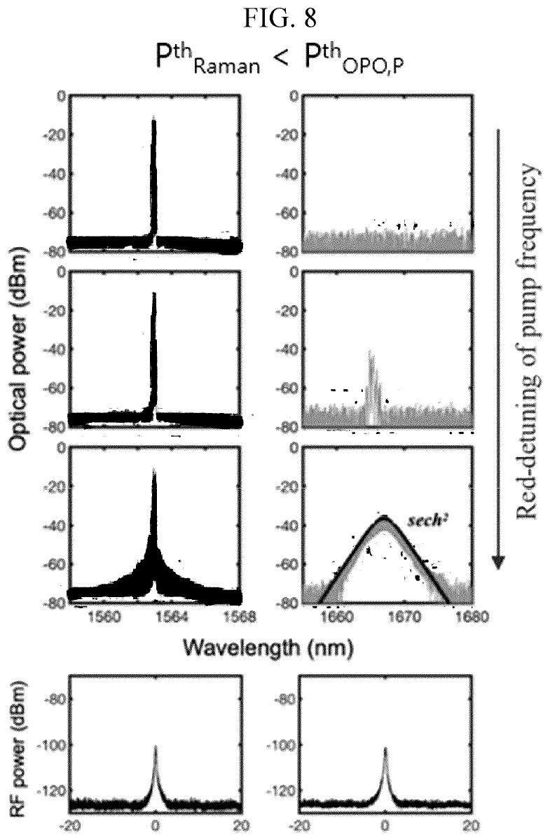

With reference to FIG. 8, in case that the threshold power P^{th}_{Raman} of the Raman scattering is lower than the threshold power P^{th}_{OPO,p} of the pump induction nonlinearity (OPO) (P^{th}_{Raman}<P^{th}_{OPO,p}), the Raman combs may be generated before the pumping induction OPO is observed in the resonator, and at the same time, the pump combs may be generated by the anti-stokes of the Raman combs. The generated Raman comb indicates the sech² envelope, and the RF beat note indicates the large line width (320 kHz). Unlike the case in which the threshold powers of the different nonlinear phenomena are similar, the single soliton state cannot be achieved through the pump frequency detuning. This means that the single soliton state is achieved by the interaction between the Raman scattering and the OPO process. The frequency comb having the atypical envelope at the pump wavelength is generated together with the Raman comb and has the large line width (320 kHz) similar to the Raman comb.

Referring to FIG. 9, the generated Raman single soliton may be autonomously and stably maintained for more than two hours without an external feedback system when being pumped by the unlocked free-running laser.

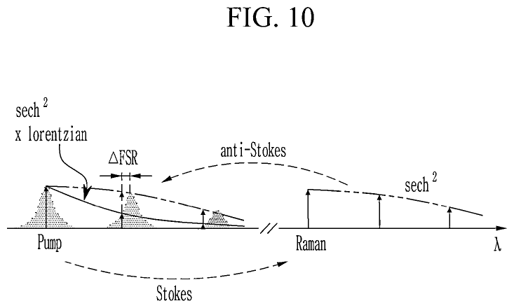

FIG. 10 is a view illustrating the generation of the atypical envelope frequency comb from the Raman comb according to one embodiment.

Referring to FIG. 10, in case that the threshold power P^{th}_{Raman} of the Raman scattering is lower than the threshold power P^{th}_{OPO,P} of the pump induction nonlinearity (OPO) (P^{th}_{Raman}<P^{th}_{OPO,p}), the pump combs may be generated by the anti-stokes of the Raman combs.

When the Raman comb with the sech² envelope accumulates enough power to induce an anti-stokes process, the Raman comb is transmitted back to the pump wavelength region. In this case, the Raman comb and the anti-stokes comb have the same repetition rate and are determined by an FSR in the original Raman comb mode at λ_{R}. However, because of the secondary dispersion of the resonator, the FSR of the pump-comb mode at λ_{P} is different from the repetition rate of the anti-stokes comb, resulting in a frequency inconsistency. The ΔFSR estimated from the experiment is approximately 6 MHz. The actual frequency difference between a comb line whose mode number deviates by m from the pump wavelength and the corresponding resonant frequency increases by m×ΔFSR. As a result, the optical intensity of each comb line in the anti-stokes comb is reduced compared to the optical intensity of the original Raman comb. The extent of reduction is determined by the line shape (Lorentzian) and line width (7.1 MHz, calculated from the total Q-factor) of the pump mode.

As a result, the sech² envelope of the Raman comb is corrected to a Lorentzian×sech² function (A×sech²(x/B)× (1/(x² (C/2)²)+D,A=6.5×10⁻³, B=190, C=15, D=2.3×10⁻⁵). The result shows a good consistency between the measured and calculated envelopes.

As described above, with the resonator module 130 capable of adjusting the coupling between the resonator and the waveguide, it is possible to characterize various spectrum dynamics of the frequency comb by adjusting the relative threshold power between the pump induction OPO and the Raman scattering that are the different nonlinear phenomena. In particular, the sech² envelope Raman comb having the large RF line width (320 kHz) is generated through the Raman scattering photon, and at the same time, the Raman single soliton may be spontaneously and deterministically generated under the particular condition. The generated soliton may be the self-locked single soliton and be generated and maintained without an external locking mechanism. Unlike the Brillouin soliton that requires the FSR suitable to generate the SBS in the micro-cavity, the soliton having various repetition rates may be generated without this constraint. The frequency comb having the atypical envelope may be generated through the anti-stokes process from the Raman comb.

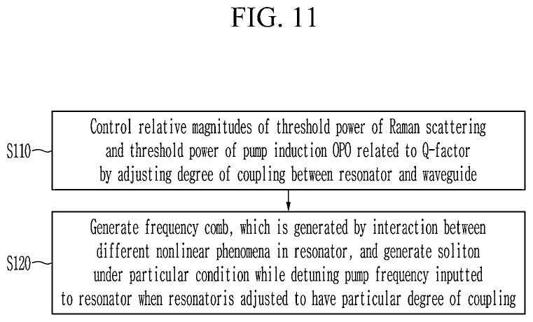

FIG. 11 is a flowchart illustrating a method of generating optical frequency combs and solitons according to one embodiment.

Referring to FIG. 11, the apparatus 100 may control relative magnitudes of the threshold power P^{th}_{Raman} of the Raman scattering and the threshold power P^{th}_{OPO,P} of the pump induction OPO related to the Q-factor by adjusting the degree of coupling between the resonator and the waveguide (S110). The apparatus 100 may include the resonator module capable of adjusting the degree of coupling between the resonator and the waveguide that generates the nonlinear optical phenomena. For example, the degree of coupling may be adjusted by using the coupling lengths of the resonator and the tapered optical fiber attached to the resonator. The apparatus 100 adjusts the Q-factor by using the coupling lengths of the resonator and the tapered optical fiber attached to the resonator, and as a result, it is possible to control relative magnitudes of the threshold power P^{th}_{Raman} of the Raman scattering and the threshold power P^{th}_{OPO,p} of the pump induction nonlinearity (OPO) related to the Q-factor by adjusting the coupling between the resonator and the waveguide.

In case that the resonator is adjusted to have a particular degree of coupling, the apparatus 100 generates the frequency combs (the pump comb at the pump wavelength and/or the Raman comb at the Raman scattering wavelength), which are generated by the interaction between the different nonlinear phenomena in the resonator, and generates the soliton under the particular condition while detuning the pump frequency inputted to the resonator (S120). In case that P^{th}_{Raman} is higher than P^{th}_{OPO,p} by the degree of coupling, the apparatus 100 may generate the pump comb by the pump wavelength induction OPO in accordance with the pump frequency detuning. In case that P^{th}_{Raman} is similar to P^{th}_{OPO,p} by the degree of coupling, the apparatus 100 may simultaneously generate the pump comb by the pump wavelength induction OPO and the Raman comb by the Raman scattering in accordance with the pump frequency detuning and spontaneously generate the soliton under the particular pump detuning condition. In case that P^{th}_{Raman} is lower than P^{th}_{OPO,P} by the degree of coupling, the apparatus 100 may generate the Raman combs by the Raman scattering in accordance with the pump frequency detuning and generate the pump combs by the anti-stokes of the Raman combs.

As described above, according to the embodiment, the relative threshold power between the different nonlinear phenomena may be adjusted by adjusting the coupling between the resonator and the waveguide. As a result, it is possible to control the interaction dynamics between the optical parametric oscillation and the Raman scattering, which are the different nonlinear phenomena, and to use the joint effect of the different nonlinear phenomena.

According to the embodiment, the single resonator may simultaneously generate the optical frequency combs of the stable spectrum at the wavelengths distant from one another without an additional process and use the combs generated in the desired wavelength region, as necessary.

According to the embodiment, the self-locked single soliton may be spontaneously and deterministically generated and maintained under the particular condition without an external locking mechanism.

According to the embodiment, the setup is simple because the stabilization through the feedback apparatus is not required.

According to the embodiment, the pumping may be performed in an anomalous dispersion region, and then the Kerr nonlinearity and the Raman nonlinearity may be simultaneously used by adjusting the coupling, unlike studies in the related art in which pumping is performed in a normal dispersion region in order to generate general Raman combs.

According to the embodiment, it is possible to generate the soliton having various repetition rates, unlike the Brillouin scattering soliton limited to a particular repetition rate.

The above-mentioned exemplary embodiments of the present disclosure are not implemented only by the device and the method. The exemplary embodiments of the present disclosure may be implemented by programs for realizing functions corresponding to the configuration of the exemplary embodiment of the present disclosure or recording media on which the programs are recorded.

Although the embodiments of the present disclosure have been described in detail above, the right scope of the present disclosure is not limited thereto, and it should be construed that many variations and modifications made by those skilled in the art using the basic concept of the present disclosure, which is defined in the following claims, will also belong to the right scope of the present disclosure.

What is claimed is:

1. An apparatus for generating optical frequency combs and solitons, the apparatus comprising:
a pump laser configured to output a pump signal with a pump wavelength; and
a resonator module connected to the pump laser through an optical path and including a resonator and a waveguide structured to adjust a degree of coupling,
wherein the resonator generates at least one of pump combs at the pump wavelength, Raman combs at a Raman scattering wavelength or solitons, through different nonlinear phenomena.

2. The apparatus of claim 1, wherein the degree of coupling is adjusted based on a coupling length of the waveguide attached to the resonator.

3. The apparatus of claim 1, wherein the waveguide comprises a tapered optical fiber or monolithically integrated waveguide attached to the resonator.

4. The apparatus of claim 1, wherein relative magnitudes of threshold power of Raman scattering and threshold power of optical parametric oscillation (OPO) induced by the pump signal are controlled based on the degree of coupling.

5. The apparatus of claim 4, wherein the resonator module generates the pump comb at the pump wavelength by pump frequency detuning when the coupling between the resonator and the waveguide is adjusted so that the threshold power of the Raman scattering is higher than the threshold power of the OPO.

6. The apparatus of claim 4, wherein the resonator module generates the pump comb at the pump wavelength and the Raman comb at the Raman scattering wavelength by pump frequency detuning when the coupling between the resonator and the waveguide is adjusted so that the threshold power of the Raman scattering is similar to the threshold power of the OPO.

7. The apparatus of claim 6, wherein the resonator module further generates the soliton spontaneously under a particular pump detuning condition.

8. The apparatus of claim 4, wherein the resonator module generates the Raman comb at the Raman scattering wavelength by pump frequency detuning and generates the pump comb by anti-stokes of the Raman comb when the coupling between the resonator and the waveguide is adjusted so that the threshold power of the Raman scattering is lower than the threshold power of the OPO.

9. A method of operating an apparatus for generating frequency combs and solitons, the method comprising:
controlling a relative threshold power of a first nonlinear phenomenon at a first wavelength related to a Q-factor and a second nonlinear phenomenon at a second wavelength by adjusting a degree of coupling between a resonator and a waveguide; and
generating frequency combs generated by different nonlinear phenomena in the resonator while detuning a pump frequency inputted to the resonator when the resonator is adjusted to have a particular degree of coupling,
wherein the second wavelength is longer than the first wavelength.

10. The method of claim 9, wherein the first nonlinear phenomenon is optical parametric oscillation (OPO) induced by a pump signal, and
the second nonlinear phenomenon is Raman scattering.

11. The method of claim 9, wherein the generating the frequency comb comprises
generating the comb at the first wavelength by the first nonlinear phenomenon in accordance with detuning of the pump frequency when the coupling between the resonator and the waveguide is adjusted so that the threshold power of the second nonlinear phenomenon is higher than the threshold power of the first nonlinear phenomenon.

12. The method of claim 9, wherein the generating the frequency comb comprises
generating the comb at the first wavelength and the comb at the second wavelength by the interaction between the first nonlinear phenomenon and the second nonlinear phenomenon in accordance with detuning of the pump frequency when the coupling between the resonator and the waveguide is adjusted so that the threshold power of the second nonlinear phenomenon is similar to the threshold power of the first nonlinear phenomenon.

13. The method of claim 12, further comprising:
spontaneously generating the soliton under a particular pump detuning condition.

14. The method of claim 9, wherein the generating the frequency comb comprises
generating the comb at the second wavelength by the second nonlinear phenomenon and generating the comb at the first wavelength by anti-stokes of the comb generated at the second wavelength in accordance with detuning of the pump frequency when the coupling between the resonator and the waveguide is adjusted so that the threshold power of the second nonlinear phenomenon is lower than the threshold power of the first nonlinear phenomenon.

15. The method of claim 9, wherein
the degree of coupling between the resonator and the waveguide is adjusted based on a coupling length of the optical waveguide attached to the resonator.
